(19) United States
(12) Patent Application Publication
(10) Pub. No.: US 2024/0163436 A1
(43) Pub. Date: May 16, 2024

(54) JUST NOTICEABLE DIFFERENCES-BASED VIDEO ENCODING

(71) Applicant: Apple Inc., Cupertino, CA (US)

(72) Inventors: Wei LI, Saratoga, CA (US); Hye-Yeon CHEONG, Los Gatos, CA (US); Jiancong LUO, San Diego, CA (US); Linfeng GUO, Cupertino, CA (US)

(21) Appl. No.: 17/988,216

(22) Filed: Nov. 16, 2022

(51) Int. Cl. H04N 19/124; H04N 19/105; H04N 19/176; H04N 19/61

(52) U.S. Cl. CPC H04N 19/124; H04N 19/105; H04N 19/176; H04N 19/61

(57) ABSTRACT

Techniques are disclosed for achieving quantization in video coding applications that achieves high coding efficiency and retains high image quality. These techniques employ quantization processes using quantization parameters that have been developed according to Just Noticeable Difference (“JND”) models for estimating coding artifacts from video coding. According to these techniques, an input pixel block of video is predictively coded with reference to a prediction reference, and prediction residuals obtained therefrom are transformed to transform domain coefficients. A transform coefficient is quantized by a quantization parameter read from a table populated by JND-quality quantization values, which is indexed by a value representing a statistical analysis of the input pixel block.

### BACKGROUND

The present disclosure relates to techniques for coding and decoding video information. In particular, it relates to techniques for coding video according to quantization processes that utilize quantization parameters that are selected to avoid coding artifacts in recovered video that exceed levels determined to be Just Noticeable Difference-levels of coding quality.

Quantization is a process used by many coders to reduce the magnitude of various data items before those data items are transmitted. For example, it often occurs that transform coefficients are quantized by quantization parameters in which the transform coefficient's value is divided by the quantization parameter. During a decoding process, the quantized coefficient maybe “dequantized,” which multiplies the quantized coefficient by the same quantization parameter that was applied during quantization. Oftentimes, a fractional part of the quantized coefficient is discarded prior to transmission. For this reason, quantization may yield a recovered transform coefficient that approximates but does not have the same value as the transform coefficient prior to quantization.

It often occurs that quantization of some transform coefficients with relatively small coefficient values truncates them to zero. Many video coders leverage this phenomenon to achieve high coding efficiency. They employ entropy coding techniques that scan across transform coefficients and count the number of consecutively-scanned coefficient positions that have zero-valued quantized coefficients. When large numbers of zero-valued quantized coefficients are encountered by these techniques, it leads to high coding efficiency. Thus, when a video coder applies strong quantization, doing so can lead to high coding efficiencies at the cost of lost image information. And, as a corollary, when a video coder applies weak quantization, doing so can lead to high retention of image information at the cost of low coding efficiencies.

### BRIEF DESCRIPTION OF THE DRAWINGS

FIG. 1 illustrates a simplified block diagram of a video delivery system according to an embodiment of the present disclosure.

FIG. 2 is a functional block diagram of a coding system according to an embodiment of the present disclosure.

FIG. 3 is a functional block diagram of a quantizer according to an embodiment of the present disclosure.

FIG. 4 is a functional block diagram of a system to generate quantization tables.

FIG. 5 illustrates a quantizer according to another embodiment of the present disclosure.

FIG. 6 is a functional block diagram of a system to train a neural network according to an embodiment of the present disclosure.

FIG. 7 is a functional block diagram of a decoding system according to an embodiment of the present disclosure.

### DETAILED DESCRIPTION

The present disclosure is directed to techniques for achieving quantization in video coding applications that achieves high coding efficiency and retains high image quality. These techniques employ quantization processes using quantization parameters that have been developed according to Just Noticeable Difference (“JND”) models for estimating coding artifacts from video coding. According to these techniques, an input pixel block of video is predictively coded with reference to a prediction reference, and prediction residuals obtained therefrom are transformed to transform domain coefficients. A transform coefficient is quantized by a quantization parameter read from a table populated by JND-quality quantization values, which is indexed by a value representing a statistical analysis of the input pixel block.

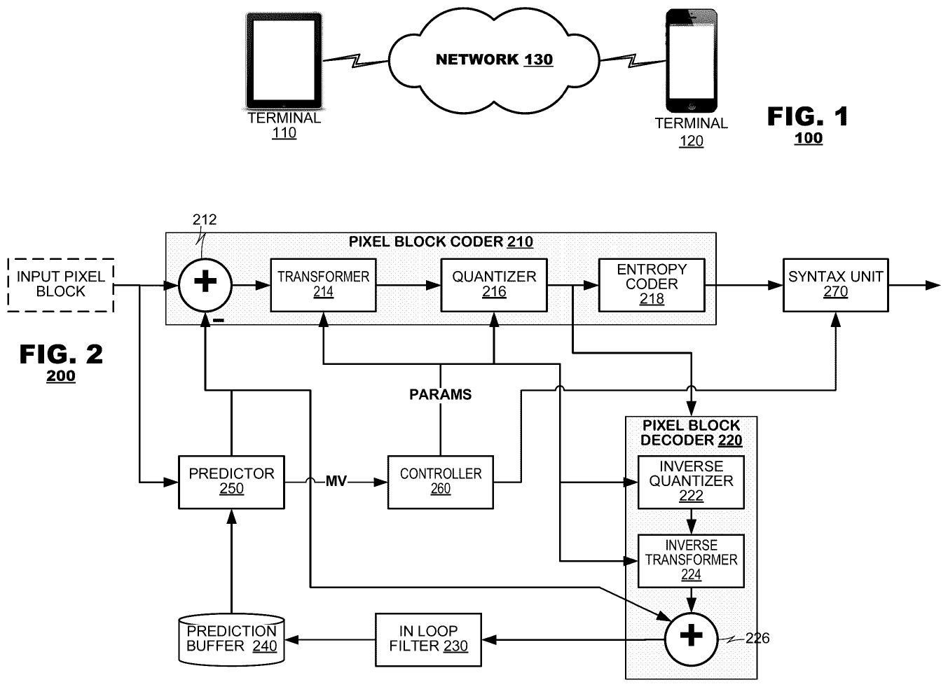

FIG. 1 illustrates a simplified block diagram of a video delivery system 100 according to an embodiment of the present disclosure. The system 100 may include a plurality of terminals 110, 120 interconnected via a network 130. The terminals 110, 120 may code video data for transmission to their counterparts via the network 130. Thus, a first terminal 110 may capture video data locally, code the video data and transmit the coded video data to the counterpart terminal 120 via the network 130. The receiving terminal 120 may receive the coded video data, decode it, and render it locally, for example, on a display at the terminal 120. If the terminals are engaged in bidirectional exchange of video data, then the terminal 120 may capture video data locally, code the video data and transmit the coded video data to the counterpart terminal 110 via another channel. The receiving terminal 110 may receive the coded video data transmitted from terminal 120, decode it, and render it locally, for example, on its own display.

A video coding system 100 may be used in a variety of applications. In a first application, the terminals 110, 120 may support real time bidirectional exchange of coded video to establish a video conferencing session between them. In another application, a terminal 110 may code pre-produced video (for example, television or movie programming) and store the coded video for delivery to one or, often, many downloading clients (e.g., terminal 120). In yet another application, a terminal 110 may code video generated by a computer application (not shown) operating on the terminal 110 for delivery to one or more other terminals 120. Thus, the video being coded may be live or pre-produced, and the terminal 110 may act as a media server, delivering the coded video according to a one-to-one or a one-to-many distribution model. For the purposes of the present discussion, the type of video and the video distribution schemes are immaterial unless otherwise noted.

In FIG. 1, the terminals 110, 120 are illustrated as tablet computers and smart phones, respectively, but the principles of the present disclosure are not so limited. Embodiments of the present disclosure also find application with computers (both desktop and laptop computers), computer servers, media players, gaming equipment, dedicated video conferencing equipment and/or dedicated video encoding equipment.

The network 130 represents any number of networks that convey coded video data between the terminals 110, 120, including for example wireline and/or wireless communication networks. The communication network 130 may exchange data in circuit-switched or packet-switched channels. Representative networks include telecommunications networks, local area networks, wide area networks, and/or the Internet. For the purposes of the present discussion, the architecture and topology of the network 130 are immaterial to the operation of the present disclosure unless otherwise noted.

FIG. 2 is a functional block diagram of a coding system 200 according to an embodiment of the present disclosure. The system 200 may include a pixel block coder 210, a pixel block decoder 220, an in-loop filter system 230, a prediction buffer 240, a predictor 250, a controller 260, and a syntax unit 270. The pixel block coder and decoder 210, 220 and the predictor 250 may operate iteratively on individual pixel blocks of a source frame of video. The predictor 250 may predict data for use during coding of a newly-presented input pixel block. The pixel block coder 210 may code the new pixel block by predictive coding techniques and present coded pixel block data to the syntax unit 270. The pixel block decoder 220 may decode the coded pixel block data, generating decoded pixel block data therefrom. The in-loop filter 230 may perform various filtering operations on decoded frame data that is assembled from the decoded pixel blocks obtained by the pixel block decoder 220. The filtered frame data may be stored in the prediction buffer 240 where it may be used as a source of prediction of a later-received pixel block. The syntax unit 270 may assemble a data stream from the coded pixel block data which conforms to a governing coding protocol.

The pixel block coder 210 may include a subtractor 212, a transformer 214, a quantizer 216, and an entropy coder 218. The pixel block coder 210 may accept pixel blocks of input data at the subtractor 212. The subtractor 212 may receive predicted pixel blocks from the predictor 250 and may generate an array of pixel residuals therefrom representing pixel-wise differences between the input pixel block and the predicted pixel block. The transformer 214 may apply a transform to the pixel residuals from the subtractor 212 to convert the prediction residuals from the pixel domain to a domain of transform coefficients. The quantizer 216 may perform quantization of transform coefficients output by the transformer 214. The quantizer 216 may be a uniform or a non-uniform quantizer. The entropy coder 218 may reduce bandwidth of the output of the quantizer 216 by coding the output, for example, by variable length code words.

During operation, the transformer 214 may operate according to coding parameters that govern its mode of operation. For example, the transform mode may be selected as a discrete cosine transform (commonly, “DCT”), a discrete sine transform (“DST”), a Walsh-Hadamard transform, a Haar transform, a Daubechies wavelet transform, or the like. In an embodiment, a controller 260 may select a coding mode to be applied by the transformer 214, which may configure the transformer 214 accordingly. The selected transform mode also may be signaled in the coded video data, either expressly or impliedly.

The quantizer 216 may operate according to a coefficient quantization parameter (QP) that determines a level of quantization to apply to the transform coefficients input to the quantizer 216. The quantization parameter QP also may be determined by a controller 260 and may be signaled in coded video data output by the coding system 200, either expressly or impliedly.

The pixel block decoder 220 may invert coding operations of the pixel block coder 210. For example, the pixel block decoder 220 may include an inverse quantizer 222, an inverse transformer 224, and an adder 226. The pixel block decoder 220 may take its input data from an output of the quantizer 216. Although permissible, the pixel block decoder 220 need not perform entropy decoding of entropy-coded data since entropy coding is a lossless event.

The inverse quantizer 222 may invert operations of the quantizer 216 of the pixel block coder 210 as determined by the quantization parameter QP applied to the quantizer 216. Similarly, the inverse transformer 224 may invert operations of the transformer 214 according to a transform mode selected for the transformer 214. The adder 226 may invert operations performed by the subtractor 212. It may receive the same prediction pixel block from the predictor 250 that the subtractor 212 used in generating residual signals.

Operations of the quantizer 216 likely will truncate data in by discarding fractional values of quantized coefficients prior to entropy coding. Therefore, data recovered by the pixel block decoder 220 likely will possess coding errors when compared to the input data presented to the pixel block coder 210.

The in-loop filter 230 may perform various filtering operations on recovered pixel block data. For example, the in-loop filter 230 may include a deblocking filter and a sample adaptive offset (“SAO”) filter. The deblocking filter may filter data at seams between reconstructed pixel blocks to reduce discontinuities between the pixel blocks that arise due to coding. SAO filters may add offsets to pixel values according to an SAO “type,” for example, based on edge direction/shape and/or pixel/color component level. The in-loop filter 230 may operate according to parameters that are selected by the controller 260.

The prediction buffer 240 may store filtered pixel data for use in later prediction of other pixel blocks. Different types of prediction data are made available to the predictor 250 for different prediction modes. For example, for an input pixel block, intra prediction takes a prediction reference from decoded data of the same frame in which the input pixel block is located. Thus, the prediction buffer 240 may store decoded pixel block data of each frame as it is coded. For the same input pixel block, inter prediction may take a prediction reference from previously coded and decoded frame(s) that are designated as “reference frames.” Thus, the prediction buffer 240 may store recovered frames for these reference frames.

As discussed, the predictor 250 may supply prediction data to the pixel block coder 210 for use in generating residuals. The predictor 250 may perform both inter prediction and inter prediction, compare the results obtained from each candidate prediction mode, then select a coding mode for the block based on the comparison. Inter prediction typically involves searching a prediction buffer 240 for pixel block data from among stored reference frame(s) for use in coding an input pixel block. Inter prediction may support a plurality of prediction modes, such as P mode coding and B mode coding. When inter prediction generates a prediction match, the predictor 250 may generate prediction reference indicators, such as motion vectors (MV), that identify which portion(s) of which reference frames were selected as source(s) of prediction for the input pixel block.

The predictor also may support Intra (I) mode coding. Intra prediction may search from among coded pixel block data from the same frame as the pixel block being coded that provides a closest match to the input pixel block. Intra prediction also may generate prediction reference indicators to identify which portion of the frame was selected as a source of prediction for the input pixel block. Predictors 250 also may apply prediction modes that are hybrids between intra and inter prediction.

A predictor 250 may select a final coding mode to be applied to the input pixel block. Typically, the mode decision selects the prediction mode that will achieve the lowest distortion when video is decoded given a target bitrate. Exceptions may arise when coding modes are selected to satisfy other policies to which the coding system 200 adheres, such as satisfying a particular channel behavior, or supporting random access or data refresh policies. The predictor 250 may output the prediction data to the pixel block coder and decoder 210, 220 and may supply to the controller 260 an identification of the selected prediction mode along with the prediction reference indicators corresponding to the selected mode.

The controller 260 may control overall operation of the coding system 200. The controller 260 may select operational parameters for the pixel block coder 210 and the predictor 250 based on analyses of input pixel blocks and also external constraints, such as coding bitrate targets and other operational parameters. The controller 260 it may provide coding parameters to the syntax unit 270, which may include data representing those parameters in the data stream of coded video data output by the system 200.

During operation, the system 200 of FIG. 2 may operate on pixel blocks of different granularities. For example, in quad-tree coding applications, image data of an input frame may be partitioned in largest coding units (“LCDs”) of a predetermined size and, when the system 200 determines that coding efficiencies may be obtained, partitioning the LCUs recursively into smaller coding units (“CUs”). Similarly, the controller 260 may revise operational parameters of the pixel block coder 210 at different granularities of image data, either on a per pixel block basis or on a larger granularity (for example, per frame, per slice, per LCU or another region).

Additionally, as discussed, the controller 260 may control operation of the in-loop filter 230 and the prediction unit 250. Such control may include, for the prediction unit 250, mode selection (lambda, modes to be tested, search windows, distortion strategies, etc.), and, for the in-loop filter 230, selection of filter parameters, reordering parameters, weighted prediction, etc.

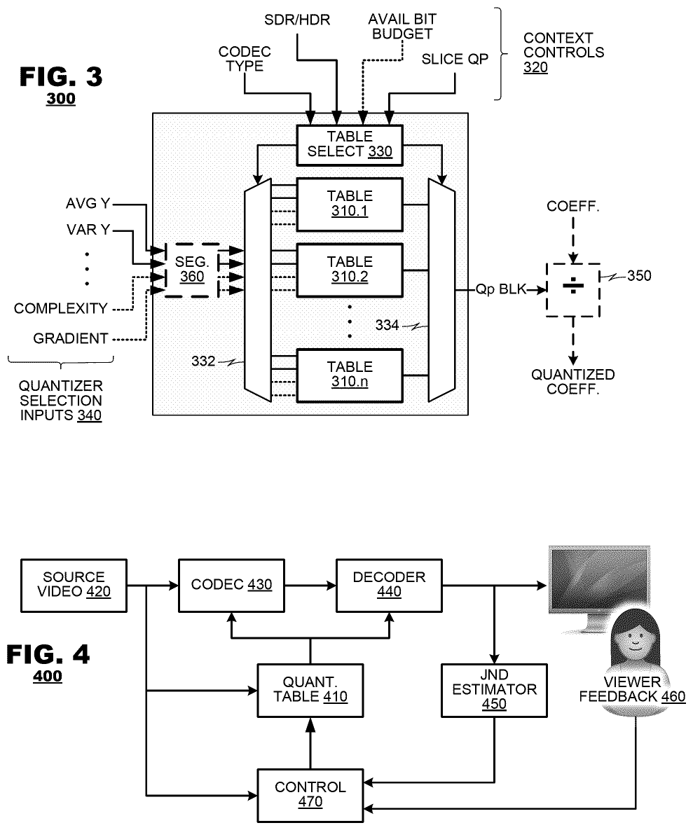

FIG. 3 is a functional block diagram of a quantizer 300 according to an embodiment of the present disclosure. The quantizer 300 may include a plurality of quantization tables 310.1-310.n each of which store quantization parameter QP values that are determined to provide JND performance in different coding contexts. The quantizer 300 may have context control inputs 320, which may select one of the quantization tables 310.1, 310.2, . . . , 310.n to be used in a particular coding context. The quantizer 300 may include a table selector 330 that determines which of the quantization tables 310.1, 310.2, . . . , 310.n is to be active in response to a given set of context control inputs 320. The quantizer 300 also may have quantizer selection inputs 340 for selecting a quantization parameter from the quantization table (say, table 310.1) selected by the table selector 330.

Quantization parameters may be output from the quantizer 300 as blocks of quantization values (shown as QP BLK). These blocks may have quantizer values at matrix positions that correspond to respective positions of transformed residuals. The quantizer 300 may perform a quantization operation (represented by divider 350) that divides each transformed residual by its respective quantization value from the QP BLK. Quantized coefficients obtained by the quantization operation 350 may be output from the quantizer 300 to a next processing stage of the pixel block coder 210 (FIG. 2). Quantized coefficients typically are truncated to integer-valued coefficients, which may cause loss of image information because truncated fractional values are not recovered when inverse quantization operations are performed on decoding.

Context coding values 320 permit the number of quantization tables 310.1-310.n to be expanded as necessary to meet individual coding needs. For example, different sets of quantization tables 310.1-310.n may be accessed when a video coder operates according to different coding protocols (e.g., AV2 vs. AV1 vs. H.265 vs. H.264). Similarly, different sets of different sets of quantization tables 310.1-310.n may be access based on a quality of video to which the input pixel block belongs, for example, whether input video is standard dynamic range (SDR) or high dynamic range (HDR). In another aspect, different sets of quantization tables 310.1-310.n may be accessed based on a quantization parameter selected by a controller (FIG. 2) for a slice to which the input pixel block belongs. In yet another aspect, different sets of quantization tables 310.1-310.n may be selected based on a bit budget that is estimated to be available for the frame to which the input pixel block belongs, as determined by a controller (FIG. 2). In practice, it is expected that quantization tables 310.1-310.n will be developed for each combination of context controls 320 that are desired for a given coding application.

Quantizer selection inputs 340 also may tailored for the coding applications for which the quantizer 300 is desired to be used. In one embodiment, a quantization parameter may be selected from the quantization table based on estimated properties of the input pixel block (FIG. 2) being coded. For example, an average luminance (AVG Y) may be estimated for an input pixel block and input to the quantizer 300 as index to a selected quantization table 310.1. Similarly, a variance of luminance (VAR Y) may be estimated for the input pixel block and input to the quantizer 300 as index to a selected quantization table 310.1. A maximum value of the pixel block's luminance can be used. A complexity of the input pixel block may be estimated for an input pixel block and input to the quantizer 300 as index to a selected quantization table 310.1. And, further, a gradient of the input pixel block's luminance may be estimated for an input pixel block and input to the quantizer 300 as index to a selected quantization table 310.1. Additionally, average variance of chrma (AVG Cr, AVG Cb), variance of chroma (VAR Cr, VAR Cb), gradients of chroma and complexity of chroma blocks may be used. In practice, it is expected that quantization tables 310.1-310.n may be indexed by some combination of these quantizer selection input 340.

It is not necessary that each unique combination of quantizer selection inputs 340 map to separate entries of a selected quantization table 310.1. In an embodiment, the quantizer 300 may include a segmenter 360 that reduce combinations of quantizer selection inputs 340 to a smaller number of table index values, which may be applied to a selected quantization table 310.1. For example, if average luminance AVG Y were represented as a 10-bit word, it would lead to 1,024 unique values; this number can be reduced to smaller number of index values (say, 16) by the segmenter 360.

FIG. 4 is a functional block diagram of a system 400 to generate quantization tables 410. The system 400 may include a quantization table 410, source video(s) 420, a video coder 430, a video decoder 440, a JND estimator 450, and a controller 460. The quantization table 410 may be pre-loaded with candidate quantization values for a given coding context that may be estimated a priori as likely to yield IND quality coding of video when a video coder 430 performs quantization.

Source videos 420 may be passed through the video coder 430 and video decoder 440 that perform coding and decoding processes on the source video 420, including quantization and dequantization according to values stored in the quantization table 410. Decoded video from the video decoder 440 may be evaluated by a IND estimator 450. The JND estimator 450 may evaluate coding artifacts present in the decoded video to determine whether they are likely to be noticeable to a human viewer. Typically, a IND estimator 450 models artifacts in recovered video based on mathematical models that estimate performance of the human visual system under different viewing conditions. JND models may estimate artifacts, for example, by applying contrast sensitivity functions (CSF), by applying luminance adaptation, and/or by estimating spatial and/or temporal masking that may occur to artifacts. In this manner, JND estimation attempts to distinguish between coding-induced artifacts that are likely to be observable by human viewers from other coding-induced artifacts that are unlikely to be observable by human viewers. The JND estimator 450 may output feedback data to the controller 460 identifying coded pixel blocks that are estimated to have artifacts that are noticeable to a human viewer under the applied JND model(s) and those that are not estimated to have noticeable artifacts.

The controller 460 may revise values stored in the quantization table 410 responsive to information from the JND estimator 450. When a pixel block is identified as having a noticeable coding artifact under applied JND model(s), the controller 460 may identify the quantization value from the table 410 that was applied during quantization of the pixel block and reduce its value in a predetermined manner. In some applications, when a pixel block is identified as not having a noticeable coding artifact under applied JND model(s), the controller 460 may identify the quantization value from the table 410 that was applied during quantization of the pixel block and increase its value in a predetermined manner. It is expected that this process of coding and decoding source video using values from the quantization tables 410, estimating the presence of JND-level coding artifacts in recovered video, and revising the values in the quantization table 410 eventually will converge on a set of quantization values that support JND-quality coding under all circumstances for which the quantization table 410 ultimately will be used.

The system 400 of FIG. 4 may be applied to generate multiple sets of quantization tables 410 each of which is tailored for a specific coding context. In this manner, quantization tables 410 may be generated for each of the quantization tables 310.1-310.n (FIG. 3) that will be used in a video coder (FIG. 2).

In an embodiment, JND artifact estimation information may be obtained from human viewers, represented by viewer feedback 470 in FIG. 4. Source video(s) 420 may be coded and decoded 430, 440 using quantization values from the quantization table 410. Recovered video may be displayed to a human viewer, who may record information on the viewer's subjective evaluation of the displayed video. Feedback from the human viewer may be input to the controller 460, which may revise quantization values stored in the table 410 as discussed above. Human feedback may be used as an alternative or a supplement to JND estimations performed by the JND estimator 450.

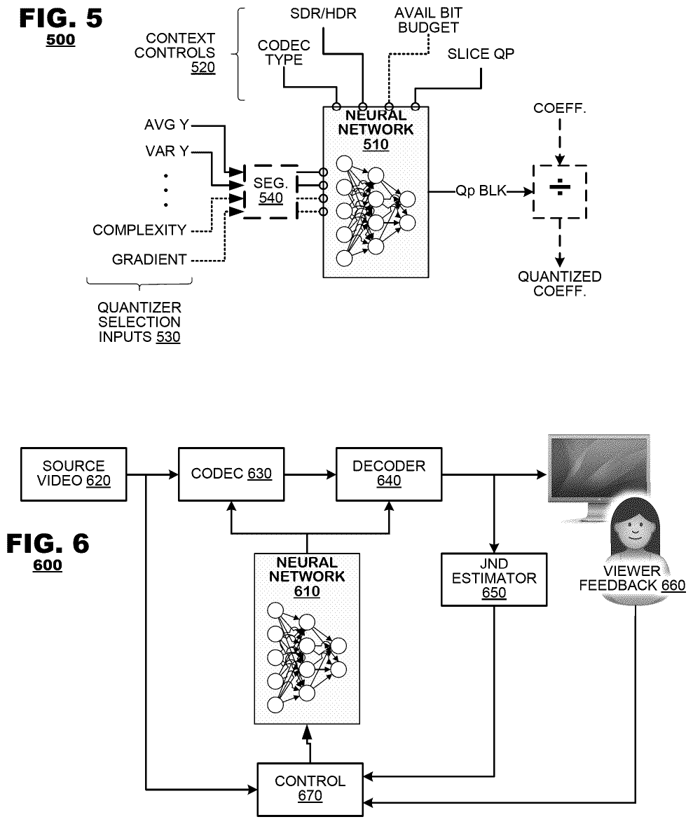

FIG. 5 illustrates a quantizer 500 according to another embodiment of the present disclosure. The quantizer 500 may include a neural network 510 that has inputs for the same input signals 530, 540 as in FIG. 3. In this embodiment, the neural network 510 may be a trained neural network that operates as determined by a set of neural network weights 520 provided for it. The neural network 510 may output quantization values QP BLK in response to the context control and quantizer selection inputs 530, 540 represented to it. Thus, the “context control” inputs 530 and the “quantizer selection” inputs 540 are so named to demonstrate that the neural network 510 responds to the same kinds of input signals are discussed above with respect to FIG. 3. In the FIG. 5 embodiment, however, inputs signals 530, 540 are presented to an input layer (not shown) of the neural network 510 as co-equal input signals.

The neural network 510 may output quantization parameters as blocks of quantization values (shown as QP BLK), which have quantizer values at matrix positions that correspond to respective positions of transformed residuals. The quantizer 500 may perform a quantization operation (represented by divider 550) that divides each transformed residual by its respective quantization value from the QP BLK. Quantized coefficients obtained by the quantization operation 550 may be output from the quantizer 500 to a next processing stage of the pixel block coder 210 (FIG. 2). Quantized coefficients typically are truncated to integer-valued coefficients, which may cause loss of image information because truncated fractional values are not recovered when inverse quantization operations are performed on decoding.

It is not necessary that each unique combination of quantizer selection inputs 540 remain unique when applied to the neural network 510. In an embodiment, the quantizer 500 may include a segmenter 560 that reduces combinations of quantizer selection inputs 540 to a smaller number of input values, which may be applied to the neural network. As discussed, if average luminance AVG Y were represented as a 10-bit word, it would lead to 1,024 unique values; this number can be reduced to smaller number of index values (say, 16) by the segmenter 560. The segmenter 560 may be applied to any input value that may be desired by system implementers, including not only the average luminance (AVG Y), variance of luminance (VAR Y), pixel block complexity, and pixel block gradients as illustrated in FIG. 5 but also to the available bit budget value that is illustrated as a context control input 530. It is expected that decisions of which input signals to condense by a segmenter 560 will be made by system implementers that tailor the quantizer 500 to suit their individual application needs.

FIG. 6 is a functional block diagram of a system 600, according to an embodiment of the present disclosure, to train a neural network 610 and, in particular, a set of neural network weights 620 that govern the neural network's operation. The system 600 may include the neural network 610 and weights 620, source video(s) 630, a video coder 640, a video decoder 650, a JND estimator 660, and a controller 670.

Source videos 630 may be passed through the video coder 640 and video decoder 650 that perform coding and decoding processes on the source video 630, including quantization and dequantization according to values output by the neural network 610. Decoded video from the video decoder 650 may be evaluated by a JND estimator 660. The JND estimator 660 may evaluate coding artifacts present in the decoded video to determine whether they are likely to be noticeable to a human viewer. Typically, a JND estimator 660 models artifacts in recovered video based on mathematical models that estimate performance of the human visual system under different viewing conditions. JND models may estimate artifacts, for example, by applying contrast sensitivity functions (CSF), by applying luminance adaptation, and/or by estimating spatial and/or temporal masking that may occur to artifacts. In this manner, JND estimation attempts to distinguish between coding-induced artifacts that are likely to be observable by human viewers from other coding-induced artifacts that are unlikely to be observable by human viewers. The JND estimator 660 may output feedback data to the controller 670 identifying coded pixel blocks that are estimated to have artifacts that are noticeable to a human viewer under the applied JND model(s) and those that are not estimated to have noticeable artifacts.

The controller 670 may revise the neural network's weights 620 responsive to information from the JND estimator 660. When a pixel block is identified as having a noticeable coding artifact under applied JND model(s), the controller 670 may identify the neural network 610 pathway(s) (not shown) that caused generation of the quantization parameter that was output from the neural network 610 and alter corresponding weights 620 to make the pathway less responsive to the input values that activated them. The controller 670 also may identify other neural network 610 pathways that correspond to lower-valued quantization parameters and revise weights 620 associated with those pathways to make them more responsive to the input values associated with the coded video that generated artifacts. The converse operation may occur for coded video that does not generate JND artifacts: Weights 620 associated with neural network pathway(s) that caused generation of the quantization parameter that was output from the neural network 610 may be revised to make those pathways less responsive to the input values that activated them, and weights 620 of other neural network 610 pathways that correspond to higher-valued quantization parameters may be revised to make those pathways more responsive to the input values associated with the coded video. It is expected that this process of coding and decoding source video using the neural network 610, estimating the presence/absence of JND-level coding artifacts in recovered video, and revising weights 620 eventually will converge on a set of neural network weights 620 that support JND-quality coding under all circumstances for which the quantizer's neural network 510 (FIG. 5) ultimately will be used. When a final set of weights 620 is identified, it may be ported to quantizers of other video coders (e.g., the systems of FIGS. 2 & 5).

In an embodiment, JND artifact estimation information may be obtained from human viewers, represented by viewer feedback 680 in FIG. 6. Source video(s) 630 may be coded and decoded 640, 650 using quantization values from the neural network 610. Recovered video may be displayed to a human viewer, who may record information on the viewer's subjective evaluation of the displayed video. Feedback from the human viewer may be input to the controller 670, which may revise weights 620 as discussed above. Human feedback may be used as an alternative or a supplement to JND estimations performed by the JND estimator 660.

In many applications, it may be sufficient to provide a single set of neural network weights 520 within a quantizer system 500 (FIG. 5) that operates over a full range of context control values 530. The system 600 of FIG. 6, for example, may develop weight 620 that provide JND-quality quantization values for different sets of codecs (e.g., AV2, AV1, H.265, H.264, etc.) for which the quantizer 500 will be used. It is not required, however, to develop a single set of weights 620 for all coding contexts; in another aspect, different sets of weights 620 may be derived for each codec that will be supported. During operation of a quantizer 500 (FIG. 5), one of the many sets of weights may be applied to a neural network 510 depending on the coding context for which the quantizer 500 is being used.

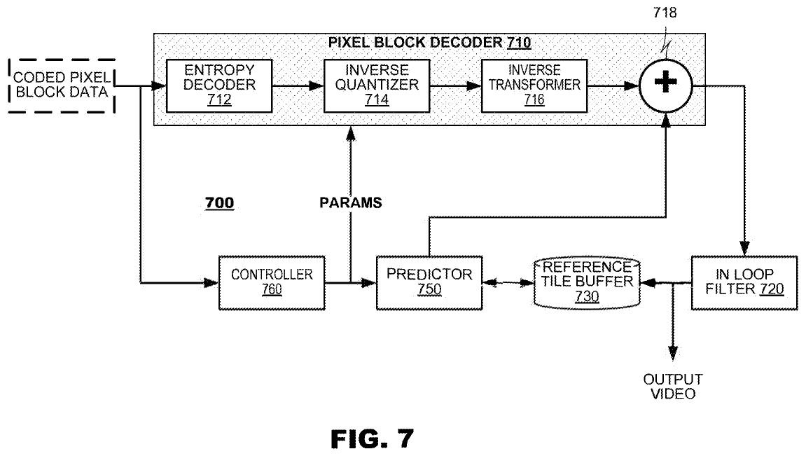

FIG. 7 is a functional block diagram of a decoding system 700 according to an embodiment of the present disclosure. The decoding system 700 may include a syntax unit 710, a pixel-block decoder 720, an in-loop filter 730, a prediction buffer 740 and a predictor 750 operating under control of a controller 760. The syntax unit 710 may receive a coded video data stream and may parse the coded data into its constituent parts. Data representing coding parameters may be furnished to the controller 760 while data representing coded residuals (the data output by the pixel block coder 210 of FIG. 2) may be furnished to the pixel block decoder 720. The pixel block decoder 720 may invert coding operations provided by the pixel block coder (FIG. 2). The in-loop filter 730 may filter reconstructed pixel block data. The reconstructed pixel block data may be assembled into frames for display and output from the decoding system 700 as output video. Frames corresponding to reference frames also may be stored in the prediction buffer 740 for use in prediction operations. The predictor 750 may supply prediction data to the pixel block decoder 720 as determined by coding data received in the coded video data stream.

The pixel block decoder 720 may include an entropy decoder 722, an inverse quantizer 724, an inverse transformer 726, and an adder 728. The entropy decoder 722 may perform entropy decoding to invert processes performed by the entropy coder 218 (FIG. 2). The inverse quantizer 724 may invert operations of the quantizer 216 of the pixel block coder 210 (FIG. 2). Similarly, the inverse transformer 726 may invert operations of the transformer 214 (FIG. 2) of the pixel block coder 210. The inverse quantizer may use the quantization parameters developed by the pixel block coder 210 for inverse quantization. Because quantization operations of the pixel block coder 210 typically truncate data, the data recovered by the pixel block decoder 720 likely will possess coding errors when compared to the input data presented to the pixel block coder 210 (FIG. 2).

The adder 728 may invert operations performed by the subtractor 212 (FIG. 2). It may receive a prediction pixel block from the predictor 750 as determined by prediction references in the coded video data stream. The adder 726 may add the prediction pixel block to reconstructed residual values output by the inverse transformer 726 and may output reconstructed pixel block data.

The in-loop filter 730 may perform various filtering operations on reconstructed pixel block data. The in-loop filter 730, for example, may include a deblocking filter and a sample adaptive offset (“SAO”) filter. Deblocking filters typically filter data at seams between reconstructed pixel blocks to reduce discontinuities between the pixel blocks that arise due to coding. SAO filters typically offset to pixel values according to an SAO type, for example, based on edge direction/shape and/or pixel level. Other types of in-loop filters may also be used in a similar manner. Operation of the in loop filter 730 ideally would mimic operation of its counterpart in the coding system 200 (FIG. 2). Thus, in the absence of transmission errors or other abnormalities, the decoded frame data obtained from the in-loop filter 730 of the decoding system 700 would be the same as the decoded frame data obtained from the in-loop filter 230 of the coding system 200 (FIG. 2); in this manner, the coding system 200 and the decoding system 700 should store a common set of reference pictures in their respective prediction buffers 240, 740.

The prediction buffer 740 may store filtered pixel data for use in later prediction of other pixel blocks. The prediction buffer 740 may store decoded pixel block data of each frame as it is coded for use in intra prediction. The prediction buffer 740 also may store decoded reference frames.

As discussed, the predictor 750 may supply prediction data to the pixel block decoder 720. The predictor 750 may supply predicted pixel block data as determined by the prediction reference indicators supplied in the coded video data stream.

The controller 760 may control overall operation of the coding system 700. The controller 760 may set operational parameters for the pixel block decoder 720 and the predictor 750 based on parameters received in the coded video data stream. As discussed, the received parameters may be set at various granularities of image data, for example, on a per pixel block basis, a per frame basis, a per slice basis, a per LCU basis, or based on other types of regions defined for the input image.

The foregoing discussion has described the various embodiments of the present disclosure in the context of coding systems, decoding systems and functional units that may embody them. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as elements of a computer program, which are stored as program instructions in memory and executed by a general processing system. In other applications, the functional blocks may be provided as discrete circuit components of a processing system, such as functional units within a digital signal processor or application-specific integrated circuit. Still other applications of the present disclosure may be embodied as a hybrid system of dedicated hardware and software components. Moreover, the functional blocks described herein need not be provided as separate elements. For example, although FIGS. 1-7 illustrate components of video coders and decoders as separate units, in one or more embodiments, some or all of them may be integrated and they need not be separate units. Such implementation details are immaterial to the operation of the present disclosure unless otherwise noted above.

Further, the figures illustrated herein have provided only so much detail as necessary to present the subject matter of the present disclosure. In practice, video coders and decoders typically will include functional units in addition to those described herein, including buffers to store data throughout the coding pipelines illustrated and communication transceivers to manage communication with the communication network and the counterpart coder/decoder device. Such elements have been omitted from the foregoing discussion for clarity.

Several embodiments of the disclosure are specifically illustrated and/or described herein. However, it will be appreciated that modifications and variations of the disclosure are covered by the above teachings and within the purview of the appended claims without departing from the spirit and intended scope of the invention.

We claim:

1. A video coding method, comprising:
predictively coding an input pixel block of video with reference to a prediction reference,
transforming prediction residuals obtained from the predictive coding to a transform domain,
quantizing at least one coefficient obtained from the transforming by:
reading a quantization parameter from a storage system populated by just noticeable difference (JND)-quality quantization values, the storage system being indexed by a value representing a statistical analysis of the input pixel block, and
quantizing the coefficient by the quantization parameter read from the storage system.

2. The video coding method of claim 1, wherein the index value is based on an estimated average luma value of the input pixel block.

3. The video coding method of claim 1, wherein the index value is based on an estimated maximum luma value of the input pixel block.

4. The video coding method of claim 1, wherein the index value is based on an estimated variance of luma values of the input pixel block.

5. The video coding method of claim 1, wherein the index value is based on an estimated complexity of the input pixel block.

6. The video coding method of claim 1, wherein the index value is based on an estimated luma gradient of the input pixel block.

7. The video coding method of claim 1, wherein the quantization value is read from a portion of the storage system identified by a coding context associated with the pixel block.

8. The video coding method of claim 7, wherein the coding context is determined, at least in part, by a codec type associated with the input pixel block.

9. The video coding method of claim 7, wherein the coding context is determined, at least in part, by a quantization parameter assigned to a slice to which the input pixel block is a member.

10. The video coding method of claim 7, wherein the coding context is determined, at least in part, by a dynamic range type associated with the input pixel block.

11. The video coding method of claim 7, wherein the coding context is determined, at least in part, by a bit budget associated with the input pixel block.

12. A video coding method, comprising:
predictively coding an input pixel block of video with reference to a prediction reference,
transforming prediction residuals obtained from the predictive coding to a transform domain,
quantizing at least one coefficient obtained from the transforming by:
reading a quantization parameter from a neural network trained with just noticeable difference (JND)-quality quantization values in response to an input value representing a luma analysis of the input pixel block, and
quantizing the coefficient by the quantization parameter read from the storage system.

13. The video coding method of claim 12, wherein the index value is based on an estimated maximum luma value of the input pixel block.

14. The video coding method of claim 12, wherein the index value is based on an estimated variance of luma values of the input pixel block.

15. The video coding method of claim 12, wherein the index value is based on an estimated complexity of the input pixel block.

16. The video coding method of claim 12, wherein the index value is based on an estimated luma gradient of the input pixel block.

17. The video coding method of claim 12, wherein the index value is based on a coding context associated with the pixel block.

18. The video coding method of claim 17, wherein the coding context is determined, at least in part, by a codec type associated with the input pixel block.

19. The video coding method of claim 17, wherein the coding context is determined, at least in part, by a quantization parameter assigned to a slice to which the input pixel block is a member.

20. The video coding method of claim 17, wherein the coding context is determined, at least in part, by a dynamic range type associated with the input pixel block.

21. The video coding method of claim 17, wherein the coding context is determined, at least in part, by a bit budget associated with the input pixel block.

22. Computer readable medium storing program instructions that, when executed by a processing device, cause the processing device to code video by:
predictively coding an input pixel block of video with reference to a prediction reference,
transforming prediction residuals obtained from the predictive coding to a transform domain,
quantizing at least one coefficient obtained from the transforming by:
reading a quantization parameter from a storage system populated by just noticeable difference (JND)-quality quantization values, the storage system being indexed by a value representing a statistical analysis of the input pixel block, and
quantizing the coefficient by the quantization parameter read from the storage system.

23. The computer readable medium of claim 22, wherein the index value is based on an estimated average luma value of the input pixel block.

24. The computer readable medium of claim 22, wherein the index value is based on an estimated variance of luma values of the input pixel block.

25. The computer readable medium of claim 22, wherein the index value is based on an estimated complexity of the input pixel block.

26. The computer readable medium of claim 22, wherein the index value is based on an estimated luma gradient of the input pixel block.

27. The computer readable medium of claim 22, wherein the quantization value is read from a portion of the storage system identified by a coding context associated with the pixel block.

28. The computer readable medium of claim 27, wherein the coding context is determined, at least in part, by a codec type associated with the input pixel block.

29. The computer readable medium of claim 27, wherein the coding context is determined, at least in part, by a quantization parameter assigned to a slice to which the input pixel block is a member.

30. The computer readable medium of claim 27, wherein the coding context is determined, at least in part, by a dynamic range type associated with the input pixel block.

31. The computer readable medium of claim 27, wherein the coding context is determined, at least in part, by a bit budget associated with the input pixel block.
